(19) United States
(12) Patent Application Publication
(10) Pub. No.: US 2008/0059941 A1
(43) Pub. Date: Mar. 6, 2008

(54) METHOD AND SYSTEM FOR SUPPORTING A COLLABORATIVE DEVELOPMENT ENVIRONMENT

(76) Inventors: Timothy Payne, Deers Green (GB); Mir Derakhshan, Bengeo (GB); Llewelyn Thomas, Stevenage (GB)

Correspondence Address: HICKMAN PALERMO TRUONG & BECKER, LLP, SUITE 550, 2055 GATEWAY PLACE, SAN JOSE, CA, 95110, US

(21) Appl. No.: 11/848,125

(22) Filed: Aug. 30, 2007

Related U.S. Application Data
(60) Provisional application No. 60/841,422, filed on Aug. 30, 2006.

(51) Int. Cl. G06F 12/00

(52) U.S. Cl. 717/100

(57) ABSTRACT

An approach is provided for supporting a collaborative development environment. A master site and a subordinate site are configured to participate in collaborative software development. One or more objects are automatically determined for replication from the master site to the subordinate site. A replication metadata file with replication metadata indicating at least the one or more objects is generated. The replication metadata file and copies of the one or more objects are transferred from the master site to the subordinate site on a first portable storage medium. An import log file on a second portable storage medium is received at the master site from the subordinate site, where the import log file includes a replication status for each of the one or more objects. The replication status for each of the one or more objects is retrieved from the import log file. The replication from the master site to the subordinate site is validated by recording the replication status for each of the one or more objects in a data repository.

### PRIORITY CLAIM

This application claims priority under 35 U.S.C. §119(e) to U.S. Provisional Patent Application Ser. No. 60/841,422, entitled “METHOD AND SYSTEM FOR SUPPORTING A COLLABORATIVE DEVELOPMENT ENVIRONMENT”, filed by Timothy Payne et ail. on Aug. 30, 2006, the entire content of which is hereby incorporated by reference for all purposes as if fully set forth herein.

### FIELD OF THE INVENTION

This invention relates generally to collaborative software development.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

In a security-conscious environment, an internal network often does not have any network connections to the outside world. Thus, it would not be possible to use traditional replication approaches to support collaborative software development that is carried out over the internal network and one or more outside networks. For example, in one operational scenario, for security reasons a particular military organization may not have any wired or wireless network connections between its sites even though the organization's sites may need to synchronize and/or replicate various types of data. In another operational scenario, multiple defense contractors and/or subcontractors may need to collaboratively develop a software project at multiple sites that have absolutely no wired or wireless network connectivity between them.

All of the prior replication approaches that have been used in such operational scenarios require at least some type of inter-site network connectivity in order to carry out data replication between multiple sites. Thus, the main disadvantage of these prior approaches is that they do not satisfy the stringent security requirements that are typically set forth in these operational scenarios. In attempting to satisfy such security requirements, the prior replication approaches typically provide security policies and restrictions on how and what type of data can be replicated over the available inter-site network connections; however, providing such security policies and restrictions comes at the cost of limited availability of the data that needs to be replicated and is prone to causing data conflicts in replicated data.

The disadvantages of the prior replication approaches described above are not unique only to operational scenarios that arise in the contexts of military organizations or collaborative software development by defense contractors and subcontractors. Rather, these disadvantages may be encountered in any type of collaborative software development where network connections between multiple development sites are not desirable or not possible for whatever reasons. For example, the disadvantages of the prior replication approaches described above would cause problems for a large software company that is developing a software product at multiple, geographically isolated sites that cannot and/or must not be connected by wired or wireless network connections.

### BRIEF DESCRIPTION OF THE DRAWINGS

In the figures of the accompanying drawings like reference numerals refer to similar elements.

FIG. 1 is a block diagram that illustrates data replication in a collaborative development environment according to an example embodiment.

FIG. 2 is a flow diagram that illustrates a method for performing data replication at a master site according to an example embodiment.

FIG. 3 is a flow diagram that illustrates a method for performing data replication at a subordinate site according to an example embodiment.

FIG. 4 is a block diagram that illustrates an example computer system on which embodiments may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. REPLICATION BY USE OF PORTABLE STORAGE MEDIA

III. TYPES OF REPLICATED OBJECTS

IV. REPLICATION METADATA FILES

V. REPLICATION OPERATIONS AT A MASTER SITE

VI. REPLICATION VALIDATION AT A MASTER SITE

VII. REPLICATION OPERATIONS AT A SUBORDINATE SITE

VIII. REPLICATING ONLY METADATA INFORMATION

IX. PER-PROJECT REPLICATION OF OBJECTS

X. IMPLEMENTATION MECHANISMS

### I. Overview

In one embodiment, a master site and a subordinate site are configured to participate in collaborative software development. One or more objects are automatically determined for replication from the master site to the subordinate site. A replication metadata file with replication metadata indicating at least the one or more objects is generated. The replication metadata file and copies of the one or more objects are transferred from the master site to the subordinate site on a first portable storage medium. An import log file on a second portable storage medium is received at the master site from the subordinate site, where the import log file includes a replication status for each of the one or more objects. The replication status for each of the one or more objects is retrieved from the import log file. The replication from the master site to the subordinate site is validated by recording the replication status for each of the one or more objects in a data repository.

In one embodiment, a master site and a subordinate site are configured to participate in collaborative software development. At the subordinate site, a replication metadata file and copies of one or more objects are received from the master site on a first portable storage medium. The replication metadata file includes replication metadata that identifies the one or more objects for replication from the master site to the subordinate site. The replication metadata file and the copies of the one or more objects are retrieved from the first portable storage medium. Based on the replication metadata, the replication is performed by importing the copies of the one or more objects into storage structures at the subordinate site. An import log file is generated based at least on the replication metadata included in the replication metadata file. The import log file includes a replication status for each of the one or more replicated objects. The import log file is transferred from the subordinate site to the master site on a second portable storage medium, where the replication statuses stored in the import log file are used at the master site to validate the replication process.

### II. Replication by use of Portable Storage Media

An approach is described herein for offline (also referred to as “air-gap”) replication between sites participating in collaborative software development. Collaborative software development involves performing development tasks on the same software project or projects at multiple sites in parallel. The replication approach described herein may facilitate replication and synchronization of software project objects among sites that do not have any wired or wireless network connectivity between them. (As used herein, “object” refers to a set of data; some of the different types of objects that can be replicated are described in a separate section heretofore.) The replication approach described herein may facilitate replication and synchronization of software project objects between sites that may be interconnected over wired or wireless network connections, but where the wired or wireless network connections cannot or should not be used for replicating objects because of various reasons (e.g., stringent security requirements, low bandwidth and/or capacity of the network connections, etc.)

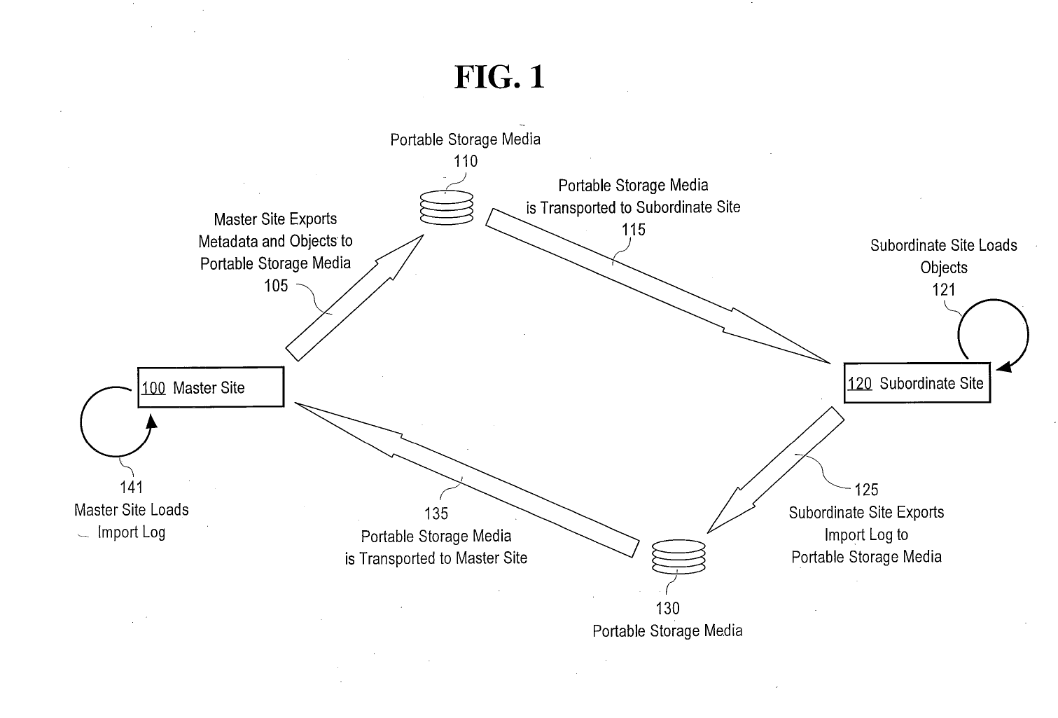

FIG. 1 is a block diagram that illustrates replication in a collaborative development environment according to an example embodiment. Master site 100 and subordinate site 120 are configured to participate in collaborative software development.

In the replication approach described herein, “site” refers to one or more computer systems that are distributively and/or separately operable to execute one or more software components. The one or more computer systems of a site may be communicatively and/or operatively coupled to one or more file systems or other repositories that store replicatable objects. For example, the one or more computer systems of a site may be coupled to local and/or network file systems that store files which can be replicated. “Master site” refers to a site which controls the replication and which has the authority to define and change a replication configuration. A “subordinate site” is a site to which objects are replicated according to a particular replication configuration. It is noted that the same site may be a master site for a particular replication configuration and a subordinate site for a different replication configuration. It is also noted that a subordinate site can send one or more objects back to a master site for a given replication configuration.

In the example embodiment illustrated in FIG. 1, each of master site 100 and subordinate site 120 may be a computer system that is operable to execute a configuration management server and a replicator process. The configuration management server is operable to control and manage software project development by supporting various development functionalities including, without limitation, versioning of project files, providing components for building executable project files, and controlling access to project files. The replicator process is a software component which, when executed by the one or more processors of the computer system, is operable to perform the functionalities of the replication approach described herein. For example, each of master site 100 and subordinate site 120 executes a replicator process that is operable to store, to portable storage medium, objects and metadata information thereof and to load, from portable storage medium, objects and the metadata information thereof that is stored on the portable storage medium.

A portable storage medium is a non-volatile, removable machine-readable medium that is operable to store data offline. Examples of a portable storage media include, without limitation, floppy disks, magnetic tapes, CD-ROMs (e.g., CD-R, CD-RW, etc), DVDs, solid-state data storage devices (e.g., flash memory cards, USB lash drives, etc), and removable external hard disks (e.g., electromagietic disks, optical disks, etc).

In the example embodiment illustrated in FIG. 1, the replication processes at master site 100 and subordinate site 120 maintain replication logs in one or more data repositories. According to the replication approach described herein, the replication logs maintained by a replicator process may comprise an export log and an import log. The replication logs may be used to provide bi-directional replication between sites as well as a 1-to-N replication between one master site and N subordinate sites.

In an operational example with respect to FIG. 1, suppose that a replication configuration is defined for the replication between master site 100 and subordinate site 120. For example, an administrator may create and store a configuration definition on master site 100. The configuration definition may include a set of information about a replication policy according to which one or more objects are replicated from master site 100 to subordinate site 120. The configuration definition may also include information indicating a software project that is associated with the one or more objects. In addition, the administrator may also define a bi-directional replication policy under which subordinate site 120 may also transfer modified objects and metadata information back to master site 100 on portable storage medium.

According to the replication approach described herein, a replicator process at master site 100 automatically determines which objects are to be replicated from the master site to one or more subordinate sites such as site 120. For example, the replication process at master site 100 may determine which objects to replicate to subordinate site 120 based on information received in an import replication log generated at subordinate site 120 during a prior replication cycle. The information received in the import replication log may indicate which objects were successfully replicated to subordinate site 120 in the previous replication cycle and, if the configured replication is bi-directional, which objects were previously modified at subordinate site 120.

As indicated by reference numeral 105, the replicator process at master site 100 transfers copies of the one or more objects that are to be replicated to portable storage medium 110. In addition to copies of the one or more objects, the replicator process at master site 100 also transfers to portable storage medium 110 a replication metadata file. The replication metadata file includes replication metadata. The replication metadata indicates at least the one or more objects that are being replicated. Further, in various embodiments the replication metadata may include various other information that may be needed to facilitate correct replication and synchronization between copies of the replicated objects stored in master site 100 and subordinate site 120.

After copies of the replicated objects and the replication metadata file are stored on portable storage medium 110, portable storage medium 110 is transported to subordinate site 120 as indicated by reference numeral 115.

A replicator process at subordinate site 120 retrieves the copies of the replicated objects and the replication metadata file from portable storage medium 110. Thereafter, as indicated by reference numeral 121, the replicator process at subordinate site 120 imports the copies of the one or more objects based at least on the replication metadata stored in the replication metadata file. For example, the replicator process may determine the project development locations where the copies of the replicated objects are to be stored based on the replication metadata.

After the copies of the replicated objects are processed, the replicator process at subordinate site 120 generates an import log that includes the replication status of each replicated object. The replication status of a replicated object indicates a particular state, of a plurality of states, of the replicated object. For example, if the replicated object is successfully imported at subordinate site 120, the replication status would be a value indicating a successful import. If the import of the replicated object has failed, then the replication status stored in the import log would be a value indicating an import error. If the replicated object has been previously received and imported at subordinate site 120, the replication status maybe a value indicating whether the new changes in the object copy received on portable storage medium 110 has been successfully applied to the previously received copy of the replicated object.

After generating the import log, as indicated by reference numeral 125 the replicator process at subordinate site 120 transfers the import log to portable storage medium 130. (In some embodiments, portable storage medium 130 may be a different portable storage medium than portable storage medium 10; in other embodiments, portable storage medium 130 may be the same as portable storage medium 110—for example, the same physical disk, CD-ROM, or flash drive.) If the replication between master site 100 and subordinate site 120 is configured as bi-directional, in step 125 the replicator process at the subordinate site may also store on portable storage medium 130 any objects at the subordinate site that have been modified since the previous replication cycle. Thereafter, portable storage medium 130 is transported to master site 100 as indicated by reference numeral 135.

The replicator process at master site 100 retrieves the import log (and any modified objects if the replication is defined as bi-directional) from portable storage medium 130. Thereafter, as indicated by reference numeral 141, the replicator process at master site 100 processes the import log. The replicator process retrieves the replication status of each replicated object from the import log and stores the retrieved replication statuses in association with the corresponding replicated objects in a data repository. In this manner, the replicator process validates the replication between master site 100 and subordinate site 120.

The data repository in which the replication is validated may be any tape of structured storage for storing data including, but not limited to, a relational or object-oriented database, a directory, a set of data files, and any other structured data storage. For example, in the operational example of FIG. 1, the data repository may be a configuration management database maintained by a configuration management server that is executing at master site 100. In this example, the replicator process at master site 100 may process the replication status of each replicated object by first determining a record in a database table that is associated with that object, and then storing the replication status for that object in a field of the record.

Thereafter, the replicator process at master site 100 may use the replication statuses stored in the data repository in a subsequent replication cycle. For example, the replicator process may automatically determine which objects need to be replicated to subordinate site 120. If some objects were not successfully replicated during the previous replication cycle, the replicator process may re-replicate these objects to subordinate site 120.

For illustration purposes, FIG. 1 depicts a replication from a master site to a single subordinate site. However, the replication approach described herein is not so limited and may be used in 1-to-N replication between the master site and N subordinate sites. In 1-to-N replication, the master site would transfer the objects that need to be replicated and a corresponding replication metadata file to each subordinate site on a separate portable storage medium. The master site would then receive a separate import log from each subordinate site on a separate portable storage medium. The master site validates the replication to each subordinate site based on the replication statuses stored in the import log received from that subordinate site in the same manner as described above with respect to subordinate site 120. Thereafter, the master site may determine the objects that need to be replicated in a subsequent replication cycle to each subordinate site based on the information stored in the import log received from that subordinate site.

In this manner, the replication approach described herein provides for replicating objects between sites that do not have, or should not use, any network connections between them. While the replication approach is described in FIG. 1 with respect to objects that are used in collaborative software development, it is noted that the approach is not limited to replicating any particular type of data. Rather, the replication approach described herein may be implemented with respect to any type of data, files, or other structured information in any operational context that includes multiple sites that do not have, or should not use, any network connections between them. In addition, the operational context illustrated in FIG. 1 may include other implementation-dependant components and elements that are not depicted in FIG. 1 in order to avoid unnecessarily obscuring the replication approach described herein. Thus, the operational context illustrated in FIG. 1 and the specific details thereof are to be regarded in an illustrative rather than a restrictive sense.

### III. Types of Replicated Objects

The replication approach described herein may be used for replicating various types of data objects in various operational contexts. In an example embodiment, the replicated objects maybe files and other project objects maintained by a configuration management server for a software project that is being developed collaboratively at multiple sites. For example, the configuration management server may be operable to control and manage the software project development by supporting versioning of project files and other project objects. Examples of project files include, without limitation source code files, object code files, and executable files.

In this example embodiment, the types of objects that may be replicated include, without limitation, items objects, change request objects, and baseline objects. An item object comprises a file and metadata information associated with that file. For example, a source item may comprise a file that stores source code and metadata information associated with that source code file. The metadata information associated with a file may include any user-defined attributes for the file including, but not limited to, a type of encoding used on the file, identifiers of one or more projects to which the file is attached, an identifier of the current owner of the file, the time at which the file was created, last accessed, and/or last updated, the version of the file, and a status reflecting the development life cycle of the file. (The status reflecting the development life cycle of the file may indicate that the file is created, reviewed, approved, tested, etc.) Replicating an item object includes replicating the file as well as any metadata information included in the item object.

A change request object (also referred to a change document object) comprises an issue and metadata information associated with that issue. Similarly to the metadata information included in an item object, an example of the metadata information included in a change request object may include, without limitation, information indicating the creator of the issue, the time the issue was created, last accessed, and/or last updated, a status reflecting the development life cycle of the issue, the user-defined properties of the issue, etc. In addition, the metadata information included in a change request object may also comprise developer-attached tags indicating various files associated with the corresponding issue as it moves through its development life cycle. The metadata information included in a change request object may also comprise information indicating the relationships between that change request object and any other item and/or change request objects. Replicating a change request object includes replicating the issue as well as any metadata information that is included in the change request object. In addition, replicating a change request object may include replicating any other item and/or change request objects (and their associated item and/or change request objects, etc.) that are associated with that change request object as indicated in the metadata information included in that object.

A baseline object comprises a collection (or collector object) of one or more item objects and/or one or more change request objects. A baseline object also comprises metadata information that may indicate the logical structure of the one or more items and/or change request objects included in the baseline object and the relationships between any item and/or change request objects. In addition, similarly to the metadata information included in item and change request objects, an example of the metadata information associated with a baseline object may include, without limitation, information indicating the creator of the baseline object, the time the baseline object was created and/or last updated, a status reflecting the development life cycle of the baseline object, any of the user-defined properties of the baseline object, etc. When a baseline object is replicated, the metadata information included with the object is replicated; further, when a baseline object is replicated, any item objects (and any metadata information included therein) associated with the baseline object may also be replicated.

### IV. Replication Metadata Files

According to the replication approach described herein, a replication metadata file is transferred from a master site to a subordinate site on a portable storage medium together with any objects that are being replicated. A replication metadata file is a file structured to store replication metadata. A non-limiting example of a replication metadata file is a text file structured according to a particular format. The replication metadata file and the replicated objects may be organized in a hierarchical structure (e.g. in one or more directories, subdirectories, and files) that is stored on the portable storage medium.

According to the replication approach described herein, the replication metadata stored in a replication metadata file includes all information that may be needed by a subordinate site to facilitate the replication in a manner that preserves the data integrity of the replicated objects and provides for synchronizing the copies of the replicated objects on the master and the subordinate sites. The replication metadata file and the replication metadata stored therein serve to drive the replication between the master site and the subordinate site(s).

For example, the replication metadata may be used to identify the objects being replicated (included, without limitation, any new, modified, and previously replicated objects) and to synchronize the objects replicated between the master site and the subordinate site(s). In another example, the replication metadata may further comprise informational that is specific to the particular types of the objects that are being replicated. For example, when the replicated objects are files, the replication metadata may include the structure of a directory and any sub-directories in which the files are stored at the master site.

In some embodiments, the replication metadata stored in a replication metadata file may comprise configuration definition for the replication between the master site and the subordinate site(s). The configuration definition may specify the project development locations where the objects being replicated are stored at the master site and the locations at the subordinate site(s) where copies of the replicated objects are to be stored. The configuration definition may also include replication configuration policies and other replication-related configuration information. For example, the configuration definition may include information indicating relevant details about any replication logs such as export logs generated at the master site that need to be loaded at the subordinate site(s) and the order in which such export logs need to be loaded. In addition, in some embodiments, the replication metadata stored in a replication metadata file may further comprise information that identifies the subordinate site or sites that are involved in the replication from the master site.

### V. Replication Operations at a Master Site

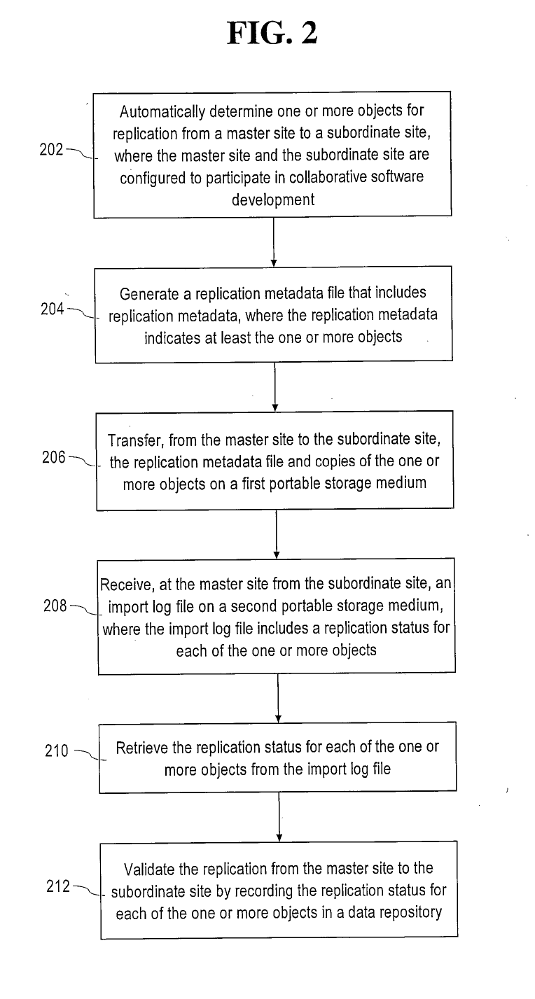

FIG. 2 is a flow diagram that illustrates a method for performing data replication at a master site according to the replication approach described herein.

In step 202, a master site (and/or a component thereof) automatically determines one or more objects for replication to a subordinate site. For example, the master site may determine which objects to replicate to the subordinate site based on information received from the subordinate site during a previous replication cycle. Such information may be received in the form of an import replication log that indicates which objects were successfully replicated to the subordinate site in the previous replication cycle and, if the configured replication is bidirectional, which objects were previously modified at the subordinate site. In another example, if this is the very first replication cycle to the subordinate site, the master site may determine which objects to replicate based on a replication configuration definition and/or on other input received from a user.

In some operational contexts, the master site may determine which objects to replicate on a periodic basis, for example, based on a configured replication schedule or by using an event-driven replication mechanism. In some operational contexts, the master site may determine which objects to replicate in response to a specific command or commands received from a user or from an automated computer process.

In some embodiments, the master site may determine that only portions of objects, but not entire objects are to be replicated to the subordinate site(s). For example, suppose that an object that is to be replicated is very large and that the master site and the subordinate site both have an existing copy of the object (for example, a copy that the master site has previously replicated to the subordinate site). In this example, the master site may determine for replicating to the subordinate site only the changes made to the object and/or only portions of the object that have been changed since the entire object was last replicated. By determining that only portions of a large object are to be replicated, but not the entire object, these embodiments provide for performing the replication to the subordinate site more efficiently and for using less storage space on the portable storage medium.

In some embodiments, the master site and the subordinate site may be configured to participate in a collaborative software development. In these embodiments, the master site may determine one or more source directories that store software project files that need to be replicated. In some embodiments, the master site may determine objects that need to be replicated to multiple subordinate sites, where the replicated objects may be the same for all subordinate sites or may be different for one or more of the subordinate sites.

In step 204, the master site (and/or the component thereof) generates a replication metadata file. The replication metadata file may include replication metadata, which identifies at least the objects that are to be replicated to the subordinate site. If this is the very first replication cycle to the subordinate site, the master site may also include a replication configuration definition as part of the replication metadata stored in the replication metadata file. In embodiments in which the replicated objects are software project files, the replication metadata may also include information specifying the name of a source directory at the master site where the project files are stored and/or the name of a target directory at the subordinate site in which the replicated files are to be stored.

In step 206, the master site (and/or the component thereof transfers current copies of the objects being replicated and the replication metadata file to the subordinate site on a first portable storage medium. According to the replication approach described herein, “transferring” to a subordinate site refers to one or more computer-implemented steps performed at a master site to facilitate storage of data on a portable storage medium that can be processed at the subordinate site. Examples of such computer-implemented steps may include, without limitation, mounting or connecting to a storage device that operates on the portable storage medium, initializing and/or formatting the portable storage medium, storing the replicated objects and replication metadata files on the portable storage medium, and storing an export status for each replicated object in a data repository. Thus, as described herein “transferring” from the master site to the subordinate site involves only computer-implemented steps that are operable to facilitate the exchange of data between the master site and the subordinate site on a portable storage medium while excluding any non-computer implemented steps that may involve the physical transportation of the portable storage medium.

In step 208, the master site (and/or a component thereof) receives from the subordinate site an import log file on a second portable storage medium. The import log file includes status information regarding the import of the replicated objects on the subordinate site. For example, the import log file may include the replication statuses of the replicated objects. In some embodiments, the import log file may include a replication status for each object that has been replicated to the subordinate site, where the replication status indicates the particular replication state of that object at the subordinate site. In other embodiments, the import log file may include a replication status only for those objects that the subordinate site has failed to import for whatever reasons. For example, in these embodiments the replication status for a particular object may be an error value indicating the reason for which the subordinate site failed to import that object.

In step 210, the master site (and/or the component thereof) retrieves the replication statuses of the replicated objects from the import log. If the replication between the master site and the subordinate site has been configured as bidirectional, the master site may also retrieve from the second portable storage medium any objects that have been modified at the subordinate site since the last replication cycle; thereafter, the master site may import or otherwise process any such modified objects and may update the replication status of these objects at the master site.

In step 212, the master site (and/or the component thereof) validates the replication based on the replication statuses received from the subordinate site in the import log on the second portable storage medium. For example, the master site may record the replication status of each replicated object in a data repository by using any mechanism that would allow the master site to determine which objects to include in a subsequent replication cycle to the subordinate site. In this manner, the master site may use the replication statuses stored in the data repository during a subsequent replication cycle to automatically determine what objects need to be replicated to the subordinate site.

### VI. Replication Validating at a Master Site

As illustrated in step 212 of FIG. 2, a master site validates the replication of objects to a subordinate site based on feedback information received from the subordinate site on a portable storage medium. According to the replication approach described herein, “validating” a replication refers to the master site determining the outcome of replicating one or more objects to the subordinate site. For example, the master site may determine that a particular object or a set of objects has been replicated to the subordinate site only when the master site receives information indicating whether the particular object or set of objects was processed at the subordinate site.

In some embodiments, when the master site receives an import log from a subordinate site on a portable storage medium, the master site (and/or a component thereof) processes the information in the import log and marks in a data repository what objects have been successfully replicated and what objects the subordinate site encountered problems with. For example, the master site may parse the import log and may store the parsed information in one or more tables of one or more databases. The parsed information may include the replication statuses of the objects that were replicated to the subordinate site during the present replication cycle. In some embodiments, the import log received on a portable storage medium from the subordinate site may include error information indicating some or all of the errors that have been generated during the importation of the replicated objects at the subordinate site. In these embodiments, the master site may also parse or otherwise process the error information and may store the parsed or processed error information in the data repository.

When the master site selects objects for replicating in the next (or any subsequent) replication cycle to the same subordinate site, the master site may consult the stored information from the one or more import logs previously generated at the subordinate site to determine which objects to replicate and what replication options to use for any objects that are selected for the next (or any subsequent) replication cycle. Thus, by processing at the master site any replication import logs that are generated at the subordinate site, the replication approach described herein provides for maintaining a complete record of each replication cycle and thus of the entire replication between the master site and the subordinate site.

For example, for any subsequent replication cycle, based on import logs previously-generated at a subordinate site, the master site may select for replication only those objects that have been modified since the last replication cycle to that particular subordinate site. This provides for more efficient processing of replicated objects at the subordinate site since objects that have not been modified since the previous replication cycle are not transferred to, and not processed at, the subordinate site.

In another example, the copy of a particular replicated object transferred from a master site to a subordinate site on a portable storage medium may be corrupt. When the subordinate site attempts to import that object from the portable storage medium, the subordinate site would fail and would record an error in the generated import log. When the import log is transferred back to the master site, the master site would process the error and would make a record of it accordingly. Thereafter, during the selection of objects for the next replication cycle, the master site would inspect the record and would determine that it needs to select the particular object again in order to provide the subordinate site with an uncorrupted copy of the object.

### VII. Replication Operations at a Subordinate Site

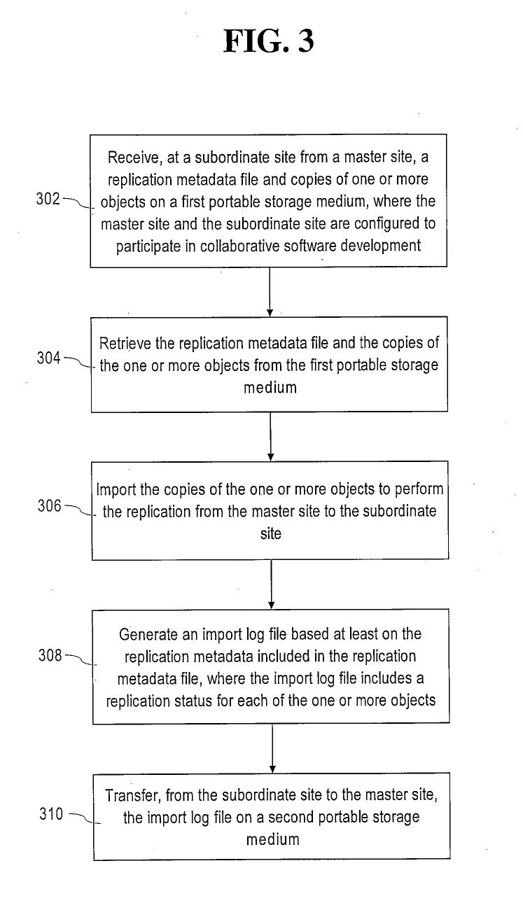

FIG. 3 is a flow diagram that illustrates a method for performing data replication at a subordinate site according to the replication approach described herein.

In step 302, the subordinate site (and/or a component thereof) receives from the master site a replication metadata file and copies of one or more objects on a first portable storage medium.

In step 304, the subordinate site (and/or the component thereof) retrieves the replication metadata file and the copies of the one or more objects from the first portable storage medium. Based on the replication metadata stored in the replication metadata file, the subordinate site then verifies that it can perform the replication specified by the master site. For example, the subordinate site may read a configuration definition included in the replication metadata file and may verify that it can perform the replication of the objects stored on the first portable storage medium. If this is the very first replication cycle to the subordinate site, the subordinate site may read the configuration definition and may initialize any data structures that are necessary to facilitate the current and any subsequent replication cycles.

For example, in some embodiments the master site and the subordinate site may be configured to participate in a collaborative software development in which the objects being replicated are software projects files. In these embodiments, the configuration definition stored in the replication metadata file may also include information specifying the name of a target directory at the subordinate site in which the replicated files are to be stored. Based on the replication metadata that identifies the one or more replicated objects, the subordinate site may initialize data structures in a data repository (e.g., one or more tables in one or more databases) that are used to store import/export status and other configuration information associated with the replicated objects.

In step 306, the subordinate site (and/or the component thereof) performs the replication by importing the copies of the one or more objects that are stored on the first portable storage medium. During the import process, the subordinate site gathers status and error information regarding the import of the objects being replicated. The status information may include replication statuses of the replicated objects, and the error inflation would indicate any errors that may have occurred.

In step 308, the subordinate site (and/or the component thereof) generates an import log that includes the status information generated during the importation step. For example, the import log would include the replication statuses generated for the replicated objects along with any error inflation that identifies errors that were encountered (if any).

In some embodiments, the import log file may include a replication status for each object that has been replicated to the subordinate site, where the replication status indicates the particular replication state of that object at the subordinate site. In other embodiments, the import log file may include a replication status only for those objects that the subordinate site has failed to import for whatever reasons. For example, in these embodiments the replication status for a particular object may be an error value indicating the reason for which the subordinate site failed to import that object.

In step 310, the subordinate site (and/or the component thereof) transfers the import log file to the master site on a second portable storage medium. In different embodiments, the second portable storage medium may be the same as or different than the first portable storage medium. If the replication between the master site and the subordinate site is configured as bi-directional, the subordinate site may also transfer to the master site on the second portable storage medium any objects that have been modified at the subordinate site since the last replication cycle. According to the replication approach described herein, “transferring” to a master site refers to one or more computer-implemented steps performed at a subordinate site to facilitate storage of data on a portable storage medium that can be processed at the master site. Examples of such computer-implemented steps may include, without limitation, mounting or connecting to a storage device that operates on the portable storage medium, initializing and/or formatting the portable storage medium, and storing the import log file (and the objects modified at the subordinate site since the last replication cycle) on the portable storage medium. Thus, as described herein “transferring” from the subordinate site to the master site involves only computer-implemented steps that are operable to facilitate the exchange of data between the subordinate site and the master site on a portable storage medium while excluding any non-computer implemented steps that may involve the physical transportation of the portable storage medium.

### VIII. Replacing only Metadata Information

In some embodiments, the replication approach described herein may provide that only metadata information included in a particular object may be replicated but not the object itself. In these embodiments, the master site and the subordinate site involved in the replication may support operations that provide for changing the metadata information separately from the object in which the metadata information is included.

For example, suppose that a particular object is owned and maintained at a particular site (the master site for that object) and is replicated to one or more subordinate sites. Suppose also that during a particular replication cycle the particular object is replicated to the subordinate site(s) that are configured to receive that object. Suppose also that after the particular object is replicated to the subordinate site(s), the metadata information included in the particular object is changed but the particular object itself remains the same. (For example, the particular object may be a source code file; a manager may review the source code included in the file and may change the development life cycle status of the file to “approved”—this operation on the source code file changes the metadata associated with the file but not the source code itself that is stored in the file.)

In this example, according to one embodiment the master site would select for replication in the subsequent replication cycle only the metadata information included in the particular object, but not the particular object itself, because the object has not been changed since the previous replication cycle The master site for the particular object may use replication logs storing information about the operations performed on that object to detect that only the metadata included in the object, but not object itself, has been changed. In this manner, the replication approach described herein provides for more efficient processing of replicated information at the subordinate site because only those portions of objects that have been modified since the previous replication cycle are transferred to, and processed at, the subordinate site.

### IX. Per-Project Replication of Objects

In one embodiment, the replication approach described herein provides for replicating of objects on a per-project basis.

For example, during the life cycle of a software development project, an object belonging to the project may be modified at different sites at different times and the project may include a large number of objects. According to the replication approach described herein, one or more logical views may be defined to include one or more subsets of objects belonging to the project. A separate replication may then be defined at a master site through a separate configuration definition for each of the one or more logical views, and the objects included in each view may then be replicated as an independent objects' set among the different subordinate development sites at which the project is being developed.

### X. Implementation Mechanisms

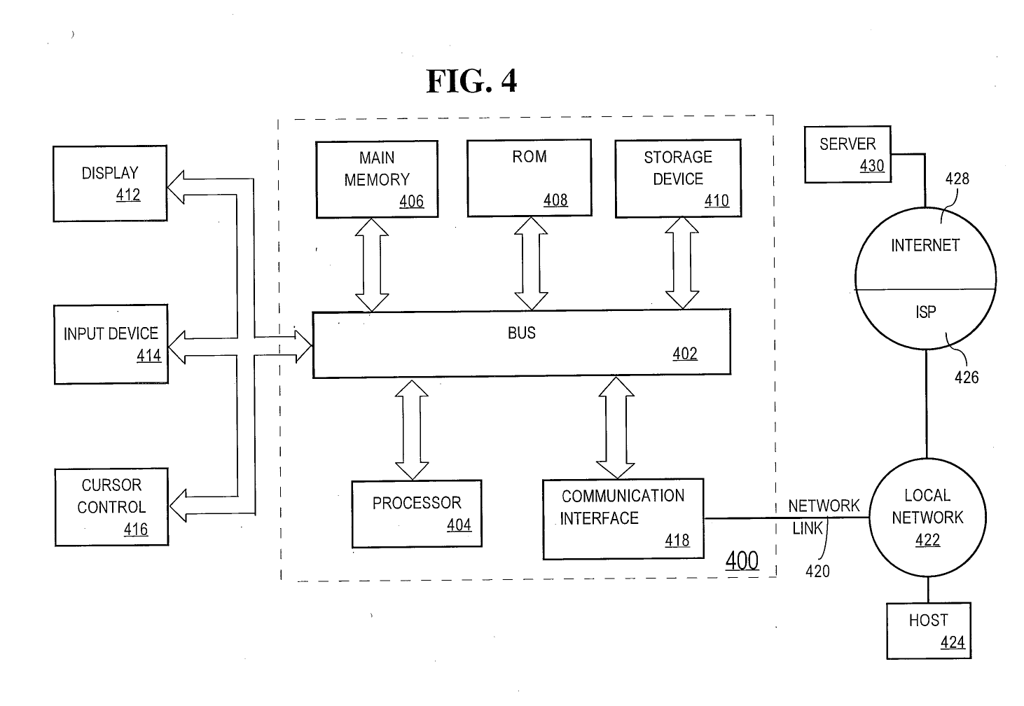

Depending upon a particular implementation, the replication approaches described herein may be implemented in any context and on any kind of computing platform or architecture, and are not limited to any particular context, computing platform, or architecture. For purposes of explanation, FIG. 4 is a block diagram that illustrates an example computer system 400 upon which embodiments of the approaches described herein may be implemented.

Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the replication approaches described herein. According to one embodiment, those approaches are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operate in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data oil bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data stress representing various types of information.

Network link 420 typically provides data communication through one or more networks to other data devices. For example, network link 420 may provide a connection through local network 422 to a host computer 424 or to data equipment operated by an Internet Service Provider (ISP) 426. USP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method comprising:
automatically determining one or more objects for replication from a master site to a subordinate site;
wherein the master site and the subordinate site are configured to participate in collaborative software development;
generating a replication metadata file that includes replication metadata, wherein the replication metadata indicates at least the one or more objects;
transferring, from the master site to the subordinate site, the replication metadata file and copies of the one or more objects on a first portable storage medium;
receiving, at the master site from the subordinate site, an import log file on a second portable storage medium, wherein the import log file includes a replication status for each of the one or more objects;
retrieving the replication status for each of the one or more objects from the import log file; and
validating the replication from the master site to the subordinate site by recording the replication status for each of the one or more objects in a data repository.

2. The computer-implemented method as recited in claim 1, further comprising:
receiving user input that specifies a configuration definition for the replication from the master site to the subordinate site, wherein the configuration definition indicates that the one or more objects participate in a software project that is collaboratively developed at the master site and the subordinate site; and
storing the configuration definition;
wherein automatically determining the one or more objects comprises determining the one or more objects based at least on the configuration definition; and
wherein the replication metadata in the replication metadata file includes the configuration definition.

3. The computer-implemented method as recited in claim 2, wherein the one or more objects include at least one of:
an item object that is included in the software project, wherein the item object comprises a file and attribute information associated with the file, wherein the attribute information comprises a version of the file:
a change request object that is associated with the software project, wherein the change request object comprises metadata information indicating one or more issues associated with the software project; and
a baseline object that is associated with the software project, wherein the baseline object comprises a collection that includes at least one of an item object and a change request object.

4. The computer-implemented method as recited in claim 1, wherein transferring the replication metadata file and the copies of the one or more objects on the first portable storage medium comprises:
storing the replication metadata file and the copies of the one or more objects on the first portable storage medium; and
storing an export status for each of the one or more objects in the data repository.

5. The computer-implemented method as recited in claim 1, further comprising:
based at least on the replication status for each of the one or more objects recorded in the data repository, automatically determining second one or more objects for second replication from the master site to the subordinate site;
generating a second replication metadata file that includes second replication metadata, wherein the second replication metadata indicates at least the second one or more objects;
transferring, from the master site to the subordinate site, the second replication metadata file and copies of the second one or more objects on a third portable storage medium;
receiving a second import log file on a fourth portable storage medium, wherein the second import log file includes a replication status for each of the second one or more objects;
retrieving the replication status for each of the second one or more objects from the second import log file; and
validating the second replication from the master site to the subordinate site by recording the replication status for each of the second one or more objects in the data repository.

6. The computer-implemented method as recited in claim 1, wherein:
the subordinate site is one of multiple subordinate sites that are configured to participate in the collaborative software development; and
the method further comprises:
transferring the replication metadata file and copies of the one or more objects on the first portable storage medium to each of the multiple subordinate sites; and
for each particular subordinate site in the multiple subordinate sites:
receiving a particular import log file that includes a particular replication status for each of the one or more objects that were transferred to the particular subordinate site;
retrieving, from the particular import log file, the particular replication status for each of the one or more objects; and
validating the replication from the master site to the particular subordinate site by recording in the data repository the particular replication status for each of the one or more objects in association with a particular identifier of the particular subordinate site.

7. The computer-implemented method as recited in claim 1, wherein the first portable storage medium is the same as the second portable storage medium.

8. The computer-implemented method as recited in claim 1, wherein:
the master site comprises a computer system that executes a configuration management server; and
the method is performed by one or more replicator processes that are executed on the computer system at the master site.

9. The computer-implemented method as recited in claim 1, wherein the master site and the subordinate site are communicatively connected over one or more network connections, wherein the one or more network connections are not used in transferring the first portable storage medium from the master site to the subordinate site and in receiving the second portable storage medium at the master site from the subordinate site.

10. A computer-implemented method comprising:
receiving, at a subordinate site from a master site, a replication metadata file and copies of one or more objects on a first portable storage medium;
wherein the master site and the subordinate site are configured to participate in collaborative software development;
wherein the replication metadata file includes replication metadata, wherein the replication metadata identifies the one or more objects for replication from the master site to the subordinate site;
retrieving the replication metadata file and the copies of the one or more objects from the first portable storage medium;
importing the copies of the one or more objects to perform the replication from the master site to the subordinate site;
generating an import log file based at least on the replication metadata included in the replication metadata file, wherein the import log file includes a replication status for each of the one or more objects; and
transferring, from the subordinate site to the master site, the import log file on a second portable storage medium.

11. The computer-implemented method as recited in claim 10, wherein:
the replication metadata in the replication metadata file includes a configuration definition for the replication from the master site to the subordinate site, wherein the configuration definition indicates that the one or more objects participate in a software project that is collaboratively developed at the master site and the subordinate site;
importing the copies of the one or more objects further comprises importing the copies of the one or more object based at least on the configuration definition; and
generating the import log file further comprises generating the import log file based at least on the configuration definition.

12. The computer-implemented method as recited in claim 10, wherein importing the copies of the one or more objects further comprises:
storing the import log file on the first portable storage medium; and
storing an import status for each of the one or more objects in a data repository.

13. The computer-implemented method as recited in claim 10, wherein:
the subordinate site comprises a computer system that executes a configuration management server; and
the method is performed by one or more replicator processes that are executed on the computer system at the subordinate site.

14. The computer-implemented method as recited in claim 10, wherein the master site and the subordinate site are communicatively connected over one or more network connections, wherein the one or more network connections are not used in receiving the first portable storage medium at the subordinate site from the master site and in transferring the second portable storage medium from the subordinate site to the master site.

15. A machine-readable medium comprising one or more stored instructions which, when processed by one or more processors, cause:
automatically determining one or more objects for replication firm a master site to a subordinate site:
wherein the master site and the subordinate site are configured to participate in collaborative software development;
generating a replication metadata file that includes replication metadata, wherein the replication metadata indicates at least the one or more objects;
transferring, from the master site to the subordinate site, the replication metadata file and copies of the one or more objects on a first portable storage medium;
receiving, at the master site from the subordinate site, an import log file on a second portable storage medium, wherein the import log file includes a replication status for each of the one or more objects;
retrieving the replication status for each of the one or more objects from the import log file; and
validating the replication from the master site to the subordinate site by recording the replication status for each of the one or more objects in a data repository.

16. The machine-readable medium as recited in claim 15, wherein the one or more stored instructions further comprise instructions which, when processed by the one or more processors, cause:
receiving user input that specifies a configuration definition for the replication from the master site to the subordinate site, wherein the configuration definition indicates that the one or more objects participate in a software project that is collaboratively developed at the master site and the subordinate site; and
storing the configuration definition;
wherein the instructions that cause automatically determining the one or more objects further comprise instructions which, when processed by the one or more processors, cause determining the one or more objects based at least on the configuration definition; and
wherein the replication metadata in the replication metadata file includes the configuration definition.

17. The machine-readable medium as recited in claim 16, wherein the one or more objects include at least one of:
an item object that is included in the software project, wherein the item object comprises a file and attribute information associated with the file, wherein the attribute information comprises a version of the file;
a change request object that is associated with the software project, wherein the change request object comprises metadata information indicating one or more issues associated with the software project; and
a baseline object that is associated with the software project, wherein the baseline object comprises a collection that includes at least one of an item object and a change request object.

18. The machine-readable medium as recited in claim 15, wherein the instructions that cause transferring the replication metadata file and the copies of the one or more objects on the first portable storage medium comprise instructions which, when processed by the one or more processors, cause:
storing the replication metadata file and the copies of the one or more objects on the first portable storage medium; and
storing an export status for each of the one or more objects in the data repository.

19. The machine-readable medium as recited in claim 15, wherein the one or more stored instructions further comprise instructions which, when processed by the one or more processors, cause:
based at least on the replication status for each of the one or more objects recorded in the data repository, automatically determining second one or more objects for second replication from the master site to the subordinate site;
generating a second replication metadata file that includes second replication metadata, wherein the second replication metadata indicates at least the second one or more objects;
transferring, from the master site to the subordinate site, the second replication metadata file and copies of the second one or more objects on a third portable storage medium;
receiving a second import log file on a fourth portable storage medium, wherein the second import log file includes a replication status for each of the second one or more objects;
retrieving the replication status for each of the second one or more objects firm the second import log file: and
validating the second replication from the master site to the subordinate site by recording the replication status for each of the second one or more objects in the data repository.

20. The machine-readable medium as recited in claim 15, wherein:
the subordinate site is one of multiple subordinate sites that are configured to participate in the collaborative software development; and
the one or more stored instructions further comprise instructions which, when processed by the one or more processors, cause:
transferring the replication metadata file and copies of the one or more objects on the first portable storage medium to each of the multiple subordinate sites; and
for each particular subordinate site in the multiple subordinate sites:
receiving a particular import log file that includes a particular replication status for each of the one or more objects that were transferred to the particular subordinate site;
retrieving, from the particular import log file, the particular replication status for each of the one or more objects; and
validating the replication from the master site to the particular subordinate site by recording in the data repository the particular replication status for each of the one or more objects in association with a particular identifier of the particular subordinate site.

21. The machine-readable medium as recited in claim 15, wherein the first portable storage medium is the same as the second portable storage medium.

22. The machine-readable medium as recited in claim 15, further comprising second one or more stored instructions which, when processed by the one or more processors, cause executing a configuration management server at the master site.

23. The machine-readable medium as recited in claim 15, wherein the master site and the subordinate site are communicatively connected over one or more network connections, wherein the one or more network connections are not used in transferring the first portable storage medium from the master site to the subordinate site and in receiving the second portable storage medium at the master site from the subordinate site.

24. A machine-readable medium comprising one or more stored instructions which, when processed by one or more processors, cause:
receiving, at a subordinate site from a master site, a replication metadata file and copies of one or more objects on a first portable storage medium;
wherein the master site and the subordinate site are configured to participate in collaborative software development;
wherein the replication metadata file includes replication metadata, wherein the replication metadata identifies the one or more objects for replication from the master site to the subordinate site;
retrieving the replication metadata file and the copies of the one or more objects from the first portable storage medium;
importing the copies of the one or more objects to perform the replication from the master site to the subordinate site;
generating an import log file based at least on the replication metadata included in the replication metadata file, wherein the import log file includes a replication status for each of the one or more objects; and
transferring, from the subordinate site to the master site, the import log file on a second portable storage medium.

25. The machine-readable medium as recited in claim 24, wherein:
the replication metadata in the replication metadata file includes a configuration definition for the replication from the master site to the subordinate site, wherein the configuration definition indicates that the one or more objects participate in a software project that is collaboratively developed at the master site and the subordinate site;
the instructions that cause importing the copies of the one or more objects further comprise instructions which, when processed by the one or more processors, cause importing the copies of the one or more object based at least on the configuration definition; and
the instructions that cause generating the import log file further comprise instructions which, when processed by the one or more processors, cause generating the import log file based at least on the configuration definition.

26. The machine-readable medium as recited in claim 24, wherein the instructions that cause importing the copies of the one or more objects further comprise instructions which, when processed by the one or more processors, cause:
storing the import log file on the first portable storage medium; and
storing an import status for each of the one or more objects in a data repository.

27. The machine-readable medium as recited in claim 24, further comprising second one or more stored instructions which, when processed by the one or more processors, cause executing a configuration management server at the subordinate site.

28. The machine-readable medium as recited in claim 24, wherein the master site and the subordinate site are communicatively connected over one or more network connections, wherein the one or more network connections are not used in receiving the first portable storage medium at the subordinate site from the master site and in transferring the second portable storage medium from the subordinate site to the master site.

29. A system comprising:
a master site comprising a first computer system and a first machine-readable medium; and
a subordinate site comprising a second computer system and a second machine-readable medium;
wherein the master site and the subordinate site are configured to participate in collaborative software development;
wherein the first machine-readable medium comprises first one or more stored instructions which, when executed on the first computer system at the master site, are operable to:
automatically determine one or more objects for replication from the master site to the subordinate site;
generate a replication metadata file that includes replication metadata, wherein the replication metadata indicates at least the one or more objects;
transfer, to the subordinate site, the replication metadata file and copies of the one or more objects on a first portable storage medium;
receive, from the subordinate site, an import log file on a second portable storage medium, wherein the import log file includes a replication status for each of the one or more objects;
retrieve the replication status for each of the one or more objects from the import log file; and
validate the replication from the master site to the subordinate site by recording the replication status for each of the one or more objects in a data repository;
wherein the second machine-readable medium comprises second one or more stored instructions which, when executed on the second computer system at the subordinate site, are operable to:
receive, from the master site, the replication metadata file and the copies of one or more objects on the first portable storage medium;
retrieve the replication metadata file and the copies of the one or more objects from the first portable storage medium;
import the copies of the one or more objects to perform the replication from the master site to the subordinate site;
generate the import log file based at least on the replication metadata included in the replication metadata file, wherein the import log file includes the replication status for each of the one or more objects; and
transfer, to the master site, the import log file on the second portable storage medium.
